(19) United States
(12) Patent Application Publication
(10) Pub. No.: US 2002/0038212 A1
(43) Pub. Date: Mar. 28, 2002

(54) Telephony system with subtitles and/or translation

(75) Inventor: Alain Bernard, Paris (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: PROSODIE, Boulogne (FR)

(21) Appl. No.: 09/960,332

(22) Filed: Sep. 24, 2001

(30) Foreign Application Priority Data
Sep. 25, 2000 (FR) 00 12153

(51) Int. Cl. G10L 17/00; G10L 15/00

(52) U.S. Cl. 704/246

(57) ABSTRACT

The system comprises telephones (12, 18), a PABX (14), a telephone network (16), a computer network (28) and terminals (30). Voice speech means (26) and/or translation means (27) are used to display a text (possibly translated) corresponding to a telephoned voice message, on the terminals (30).

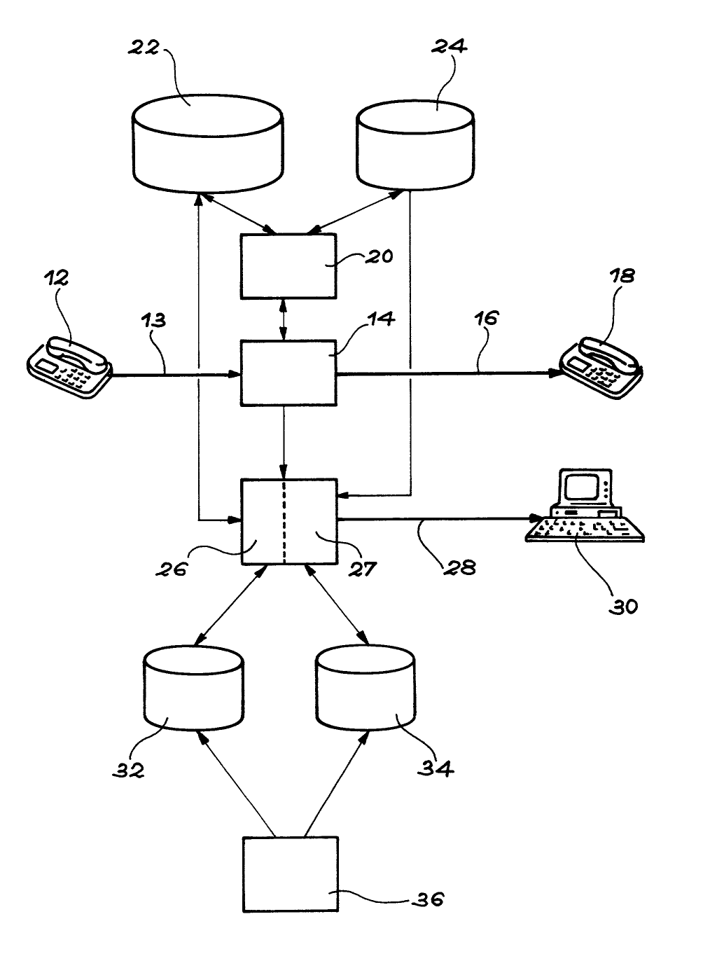

### TECHNICAL FIELD

The purpose of this invention is a telephony system with subtitles and/or translation.

1. State of Prior Art

A telephony system usually comprises telephones connected to a network through a switching means and through a digital interface. This interface is capable of extracting the number of the calling telephone, and the number of the called telephone, from the telephone signal. Some installations also include computer terminals associated with some telephones, each terminal being provided with a display screen and a computer address. These terminals are connected to a computer data transmission network.

Furthermore, a database connected to the digital interface associates the computer address of the associated terminal with the requested telephone number. Thus a telephone call can be set up between a caller and an operator, while displaying written information about the caller on the operator's terminal. For example a datasheet can be displayed, particularly showing bank data.

In these installations, the coupling between the computer network and the telephone network may be done using the technique called “Computer Telephone Coupling” (CTI).

The purpose of this invention is to improve this type of installation by offering a new comprehension assistance service.

### DISCLOSURE OF THE INVENTION

The invention is intended to combine known voice speech systems capable of recognizing the voice message output from a calling telephone, transcribing it into a written message and transmitting data to display the written message on the called telephone screen, through the computer data transmission network. In other words, the system according to the invention enables subtitles of the voice message.

Means are already known by which a user can dictate a message to a computer. For example, equipment on which the “Viavoice” software (registered trademark) made by the IBM Company or equipment made by the Dragon Dictate Company may be used. Admittedly, the result is not always perfect, but imperfections in the system do not make the system unusable for the application aimed at by the invention, since the text to be displayed is additional to the voice message and is simply an assistance to understanding it.

In one advantageous variant, this subtitle function is combined with an automatic translation function when the language used by the called telephone user is not the same as the original language of the message. In this case, the database associates an original language with the calling telephone and a translation language with the called telephone and the system comprises means of translation of the message written in the language associated with the called telephone if it is different from the original language.

Automatic translation programs are known, for example as made by the Softissimo Company. Once again, any imperfections in the translation can be accepted since the translated message is simply a support for the spoken message.

Preferably, the database contains the voice profile of some callers, this profile being learned during the various communications.

Another advantage of the system according to the invention is that voice speech means and translation means are centralized for a number of users, consequently it is easy to add means of updating dictionaries and grammar rules (general or specific) used in voice speech and translation.

The invention is applicable to all types of telephones, including mobile telephones for which the number can be representative of the caller, and not simply the location of the telephone.

### BRIEF DESCRIPTION OF THE DRAWINGS

The single figure shows the block diagram of a telephony system according to the invention.

### DESCRIPTION OF A PARTICULAR EMBODIMENT

The attached figure shows a telephone 12 connected to a telephone line 13 and switching means 14 that can be used to establish the connection through the telephone network 16 with a telephone 18. The telephone 12 is the calling telephone and the telephone 18 is the called telephone.

The system shown also comprises a digital interface 20 connected to database 22 containing data related to the caller's profile (his language, his voice identity, etc.) and a base 24 comprising computer addresses of telephones that can be called.

The system also comprises voice speech means 26 and/or translation means 27. These means are connected to a computer data transmission network 28 to which computer terminals 30 are connected.

Finally, the system comprises a database 32 fixing the vocabulary used and a database 34 containing grammar rules. These two bases are connected to update means 36.

When the user of the telephone 12 picks up the handset and dials the number of his correspondent, the PABX 14 makes the connection, the means 20 find the computer address of the called party in the base 24, and search for the original language and the caller's profile in the base 22. Voice speech means 26 input the sent voice message, transcribe it into a written text, and if the original language is not the same as the language of the called party, the means 27 translate the text. Computer data corresponding to the written text and possibly its translation are routed through the data network 28 to the terminal 30. Therefore the called party sees a text on the screen of his terminal corresponding to the voice message that he receives through the handset of his telephone 18.

1. Telephony system comprising:
telephones (12, 18) connected to a telephone network (16) through a switching means (14) and through a digital interface (20) capable of extracting the number of the calling telephone (12) and the number of the called telephone (18) from the telephone signal,
computer terminals (30) associated with at least some of the telephones (18), each terminal (30) being provided with a display screen and having a computer address, these terminals (30) being connected to a computer data transmission network (28),
a database (22, 24) connected to the digital interface (20), this database (24) associating the computer address of the associated computer terminal (30) with the number of the called telephone (18), characterized in that it also comprises speech recognition means (26) capable of recognizing the voice message output from the calling telephone (12), transcribing it into a written message and transmitting the data necessary to display the said written message on the screen of the terminal (30) associated with the called telephone (18), through the computer data transmission network (28).

2. System according to claim 1, in which the database (22) associates an original language with the calling telephone (12) and a translation language with the called telephone (18), this system also comprising automatic means (27) of translating the written message into the language associated with the called telephone (18) if it is different from the original language.

3. System according to claim 2, in which the database (22) contains the voice profile of some callers, this profile having been acquired during the various communications.

4. System according to claim 1, also comprising means (32, 34, 36) of updating the voice speech and translation means.
